(19) United States
(12) Patent Application Publication
(10) Pub. No.: US 2006/0023949 A1
(43) Pub. Date: Feb. 2, 2006

(54) Information-processing apparatus, information-processing method, recording medium, and program

(75) Inventors: Naoki Saito, Kanagawa (JP); Yusuke Sakai, Kanagawa (JP); Mikio Kamada, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/188,698

(22) Filed: Jul. 26, 2005

(30) Foreign Application Priority Data
Jul. 27, 2004 (JP) P2004-218527

(51) Int. Cl. G06K 9/64; G06K 9/00; G06K 9/46; G06K 9/62; G06K 9/68

(52) U.S. Cl. 382/217; 382/103; 382/190; 382/224

(57) ABSTRACT

The present invention provides an information-processing apparatus for communicating an image of a user to an other information-processing apparatus by way of a network. The apparatus includes input means for carrying out an operation to take an image of a user and inputting a user image obtained as a result of the operation to take the image, detection means for carrying out an operation to detect a behavior of the user from the user image and generating behavior information as a result of the operation to detect the behavior, generation means for generating a first command corresponding to the behavior information, determination means for carrying out a process to determine a relation between the first command and a second command received from the other information-processing apparatus as a command corresponding to a behavior of an other user operating the other information-processing apparatus, and control means for controlling execution of processing corresponding to a result of the process carried out by the determination means.

### CROSS REFERENCE TO RELATED APPLICATIONS

The present invention contains subject matter related to Japanese Patent Application JP 2004-218527 filed in the Japanese Patent Office on Jul. 27, 2004, the entire contents of which being incorporated herein by reference.

### BACKGROUND OF THE INVENTION

The present invention relates to an information-processing apparatus, information-processing method, recording medium, and program. More particularly, the present invention relates to an information-processing apparatus, information-processing method, recording medium, and program, which are each used for communicating an image and voice of the user to other information-processing apparatus by way of a network and driven to carry out a predetermined operation in accordance with a body language and a gesture.

The apparatus in related art used in interactions with people at locations remotely separated from each other include the telephone, the so-called TV telephone, and a video conference system. There is also a method whereby personal computers or the like are connected to the Internet and used for chats based on texts and video chats based on images and voices. Such interactions are referred to hereafter as remote communications.

In addition, there has also been proposed a system wherein people each carrying out remote communications with each other share a virtual space and the same contents such as a piece of music, a moving image, and a still image through the Internet by using personal computers or the like connected to the Internet. Such people are each referred to hereafter also as a speaker. For more information on such a system, refer to documents such as Japanese Patent Laid-open No. 2003-271530.

There is also a technology whereby an image of a speaker can be taken by using a photographing device such as a CCD (Charge Coupled Device) camera, and a body language and gesture of a speaker are detected. For more information on such a system, refer to documents such Japanese Patent Laid-open No Hei 8-211979 and Japanese Patent Laid-open No. Hei 8-212327.

### SUMMARY OF THE INVENTION

With the remote communication in related art, however, it is not possible to implement an experience common to speakers and sharing of an environment through communications among the speakers. It is thus difficult to improve the sense of mutual understanding, an atmosphere of relaxation, and the like. Accordingly, the content of a communication becomes something like merely a message and/or becomes awkward. As a result, effective mutual communication is the task.

If a behavior common to both speakers is carried out for a body language and/or gesture carried out by the speakers, for example, enhancement of a group harmony and the sense of mutual understanding can be expected. However, there is a problem raised by non-existence of such a technology.

Addressing the problems described above, inventors of the present invention have devised an information-processing apparatus capable of carrying out predetermined processing on the basis of a matching condition of a body language and gestures of speakers communicating with each other at remote locations.

Accordance to an embodiment of the present invention, there is provided a first information-processing apparatus including:
input means for carrying out an operation to take an image of a user and inputting a user image obtained as a result of the operation to take the image;
detection means for carrying out an operation to detect a behavior of the user from the user image and generating behavior information as a result of the operation to detect the behavior;
generation means for generating a first command corresponding to the behavior information;
determination means for carrying out a process to determine a relation between the first command and a second command received from the other information-processing apparatus as a command corresponding to a behavior of an other user operating the other information-processing apparatus; and
control means for controlling execution of processing corresponding to a result of the process carried out by the determination means.

The first information-processing apparatus according to an embodiment the present invention further has reproduction means for reproducing content data common to the information-processing apparatus and the other information-processing apparatus synchronously with the other information-processing apparatus.

According to an embodiment of the present invention, there is provided a first information-processing method including the steps of:
taking an image of a user and inputting a user image obtained as a result of the operation to take the image;
detecting a behavior of the user from the user image and generating behavior information as a result of the operation to detect the behavior;
generating a first command corresponding to the behavior information;
determining a relation between the first command and a second command received from the other information-processing apparatus as a command corresponding to a behavior of an other user operating the other information-processing apparatus; and
controlling execution of processing corresponding to a result of the process carried out at the determination step.

According to an embodiment of the present invention, there is provided a first recording medium for recording a program. The program includes the steps of:
taking an image of a user and inputting a user image obtained as a result of the operation to take the image;
detecting a behavior of the user from the user image and generating behavior information as a result of the operation to detect the behavior;
generating a first command corresponding to the behavior information;
determining a relation between the first command and a second command received from the other information-processing apparatus as a command corresponding to a behavior of an other user operating the other information-processing apparatus; and
controlling execution of processing corresponding to a result of the process carried out at the determination step.

Accordance to an embodiment of the present invention, there is provided a first program including the steps of:
taking an image of a user and inputting a user image obtained as a result of the operation to take the image;
detecting a behavior of the user from the user image and generating behavior information as a result of the operation to detect the behavior;
generating a first command corresponding to the behavior information;
determining a relation between the first command and a second command received from the other information-processing apparatus as a command corresponding to a behavior of an other user operating the other information-processing apparatus; and
controlling execution of processing corresponding to a result of the process carried out at the determination step.

According an embodiment of the present invention, there is provided a second information-processing apparatus including:
input means for carrying out an operation to take an image of a user operating the information-processing apparatus and inputting a first user image obtained as a result of the operation to take the image;
receiver means for receiving a second user image transmitted by the other information-processing apparatus by way of the network as an image of an other user operating the other information-processing apparatus;
detection means for carrying out an operation to detect a behavior of the user from the first user image and generating first behavior information as a result of the operation to detect the behavior of the user as well as carrying out an operation to detect a behavior of the other user from the second user image and generating second behavior information of the other user as a result of the operation to detect the behavior of the other user;
generation means for generating a first command corresponding to the first behavior information of the user and a second command corresponding to the second behavior information of the other user;
determination means for carrying out a process to determine a relation between the first and second commands;
communication means for informing the other information-processing apparatus of a result of the process carried out by the determination means through the network; and
control means for controlling execution of processing corresponding to a result of the process carried out by the determination means.

The second information-processing apparatus according to an embodiment of the present invention further has reproduction means for reproducing content data common to the information-processing apparatus and the other information-processing apparatus synchronously with the other information-processing apparatus.

According to an embodiment of the present invention, there is provided a second information-processing method including the steps of:
taking an image of a user and inputting a first user image obtained as a result of the operation to take the image;
receiving a second user image transmitted by the other information-processing apparatus by way of the network as an image of an other user operating the other information-processing apparatus;
detecting a behavior of the user from the first user image and generating first behavior information as a result of the operation to detect the behavior of the user as well as carrying out an operation to detect a behavior of the other user from the second user image and generating second behavior information of the other user as a result of the operation to detect the behavior of the other user;
generating a first command corresponding to the first behavior information of the user and a second command corresponding to the second behavior information of the other user;
determining a relation between the first and second commands;
informing the other information-processing apparatus of a result of the process carried out at the determination step through the network; and
controlling execution of processing corresponding to a result of the process carried out at the determination step.

According to an embodiment of the present invention, there is provided a second recording medium for recording a program as a recording medium including:
taking an image of a user and inputting a first user image obtained as a result of the operation to take the image;
receiving a second user image transmitted by the other information-processing apparatus by way of the network as an image of an other user operating the other information-processing apparatus;
detecting a behavior of the user from the first user image and generating first behavior information as a result of the operation to detect the behavior of the user as well as carrying out an operation to detect a behavior of the other user from the second user image and generating second behavior information of the other user as a result of the operation to detect the behavior of the other user;
generating a first command corresponding to the first behavior information of the user and a second command corresponding to the second behavior information of the other user;
determining a relation between the first and second commands;
informing the other information-processing apparatus of a result of the process carried out at the determination step through the network; and
controlling execution of processing corresponding to a result of the process carried out at the determination step.

According to an embodiment of the present invention, there is provided a second program including the steps of:
taking an image of a user and inputting a first user image obtained as a result of the operation to take the image;
receiving a second user image transmitted by the other information-processing apparatus by way of the network as an image of an other user operating the other information-processing apparatus;
detecting a behavior of the user from the first user image and generating first behavior information as a result of the operation to detect the behavior of the user as well as carrying out an operation to detect a behavior of the other user from the second user image and generating second behavior information of the other user as a result of the operation to detect the behavior of the other user;
generating a first command corresponding to the first behavior information of the user and a second command corresponding to the second behavior information of the other user;
determining a relation between the first and second commands;
informing the other information-processing apparatus of a result of the process carried out at the determination step through the network; and
controlling execution of processing corresponding to a result of the process carried out at the determination step.

According to an embodiment of the present invention, there is provided a third information-processing apparatus including:
input means for carrying out an operation to take an image of a user and inputting a user image obtained as a result of the operation to take the image;
detection means for carrying out an operation to detect a behavior of the user from the user image and generating first behavior information as a result of the operation to detect the behavior;
notification means for notifying a predetermined server of the first behavior information through the network;
receiver means for receiving a determination result transmitted by the predetermined server in response to the first behavior information transmitted by the notification means to the predetermined server as a determination result on a state of a relation with second behavior information received by the predetermined server from the other information-processing apparatus; and
control means for controlling execution of processing corresponding to the determination result received by the receiver means.

It is possible to provide a configuration in which the predetermined server generates a first command corresponding to the first behavior information and a second command corresponding to the second behavior information received from the other information-processing apparatus as information on a behavior of a user operating the other information-processing apparatus, produces a determination result on a relation between the first and second commands and transmits the determination result to the information-processing apparatus.

The third information-processing apparatus according to an embodiment the present invention further has reproduction means for reproducing content data common to the information-processing apparatus and the other information-processing apparatus synchronously with the other information-processing apparatus.

According to an embodiment of the present invention, there is provided a third information-processing method including the steps of:
taking an image of a user and inputting a user image obtained as a result of the operation to take the image;
detecting a behavior of the user from the user image and generating first behavior information as a result of the operation to detect the behavior;
notifying a predetermined server of the first behavior information through the network;
receiving a determination result transmitted by the predetermined server in response to the first behavior information transmitted in a process carried out at the notification step to the predetermined server as a determination result on a state of a relation with second behavior information received by the predetermined server from the other information-processing apparatus; and
controlling execution of processing corresponding to the determination result received in a process carried out at the receiver step.

According to an embodiment of the present invention, there is provided a third recording medium for recording a program as a recording medium including the steps of:
taking an image of a user and inputting a user image obtained as a result of the operation to take the image;
detecting a behavior of the user from the user image and generating first behavior information as a result of the operation to detect the behavior;
notifying a predetermined server of the first behavior information through the network;
receiving a determination result transmitted by the predetermined server in response to the first behavior information transmitted in a process carried out at the notification step to the predetermined server as a determination result on a state of a relation with second behavior information received by the predetermined server from the other information-processing apparatus; and
controlling execution of processing corresponding to the determination result received in a process carried out at the receiver step.

According to an embodiment of the present invention, there is provided a third program including the steps of:
taking an image of a user and inputting a user image obtained as a result of the operation to take the image;
detecting a behavior of the user from the user image and generating first behavior information as a result of the operation to detect the behavior;
notifying a predetermined server of the first behavior information through the network;
receiving a determination result transmitted by the predetermined server in response to the first behavior information transmitted in a process carried out at the notification step to the predetermined server as a determination result on a state of a relation with second behavior information received by the predetermined server from the other information-processing apparatus; and
controlling execution of processing corresponding to the determination result received in a process carried out at the receiver step.

According to an embodiment of the present invention, there is provided a first information-processing apparatus including:
an input section for carrying out an operation to take an image of a user and inputting a user image obtained as a result of the operation to take the image;
a detection section for carrying out an operation to detect a behavior of the user from the user image and generating behavior information as a result of the operation to detect the behavior;
a generation section for generating a first command corresponding to the behavior information;
a determination section for carrying out a process to determine a relation between the first command and a second command received from the other information-processing apparatus as a command corresponding to a behavior of an other user operating the other information-processing apparatus; and
a control section for controlling execution of processing corresponding to a result of the process carried out by the determination section.

According to an embodiment of the present invention, there is provided a second information-processing apparatus including:
an input section for carrying out an operation to take an image of a user operating the information-processing apparatus and inputting a first user image obtained as a result of the operation to take the image;
a receiver section for receiving a second user image transmitted by the other information-processing apparatus by way of the network as an image of an other user operating the other information-processing apparatus;
a detection section for carrying out an operation to detect a behavior of the user from the first user image and generating first behavior information as a result of the operation to detect the behavior of the user as well as carrying out an operation to detect a behavior of the other user from the second user image and generating second behavior information of the other user as a result of the operation to detect the behavior of the other user;
a generation section for generating a first command corresponding to the first behavior information of the user and a second command corresponding to the second behavior information of the other user;
a determination section for carrying out a process to determine a relation between the first and second commands;
a communication section for informing the other information-processing apparatus of a result of the process carried out by the determination section through the network; and
a control section for controlling execution of processing corresponding to a result of the process carried out by the determination section.

According to an embodiment of the present invention, there is provided a third information-processing apparatus including:
an input section for carrying out an operation to take an image of a user and inputting a user image obtained as a result of the operation to take the image;
a detection section for carrying out an operation to detect a behavior of the user from the user image and generating first behavior information as a result of the operation to detect the behavior;
a notification section for notifying a predetermined server of the first behavior information through the network;
a receiver section for receiving a determination result transmitted by the predetermined server in response to the first behavior information transmitted by the notification section to the predetermined server as a determination result on a state of a relation with second behavior information received by the predetermined server from the other information-processing apparatus; and
a control section for controlling execution of processing corresponding to the determination result received by the receiver section.

In accordance with the first information-processing apparatus, the first information-processing method, and the first program, which are provided by an embodiment of the present invention, a behavior of a user is detected from a user image, behavior information is generated as a detection result, and a first command corresponding to the behavior information is generated. Then, a relation between the first command and a second command received from another information-processing apparatus as a command corresponding to a behavior of another user operating the other information-processing apparatus is determined, and execution of processing corresponding to a determination result is controlled.

In accordance with the second information-processing apparatus, the second information-processing method, and the second program, which are provided by an embodiment of the present invention, a behavior of a user is detected from a user image, first behavior information is generated as a detection result, a behavior of another user operating another information-processing apparatus is detected from a second user image obtained as a result of an operation to take an image of the other user, second behavior information is generated as a detection result, and first and second commands corresponding to the first behavior information and the second behavior information respectively are generated. Then, a relation between the first and second commands is determined, a determination result is transmitted to the other information-processing apparatus and execution of processing corresponding to the determination result is controlled.

In accordance with the third information-processing apparatus, the third information-processing method, and the third program, which are provided by an embodiment of the present invention, a behavior of a user is detected from a user image, first behavior information is generated as a detection result, and the first behavior information is transmitted to a predetermined server by way of a network. Then, a determination result transmitted by the predetermined server in response to the first behavior information is received as a determination result on a state of a relation with second behavior information received by the predetermined server from another information-processing apparatus, and execution of processing corresponding to the determination result received from the predetermined server is controlled.

According to an embodiment of the present invention, it is possible to carry out predetermined processing on the basis of a matching condition of a body language and gestures of speakers communicating with each other at remote locations.

### BRIEF DESCRIPTION OF THE DRAWINGS

These and other objects of the invention will be seen by reference to the description, taken in connection with the accompanying drawings, in which:

FIG. 1 is a diagram showing a typical configuration of a communication system according to an embodiment of the present invention;

FIGS. 2A to 2C are diagrams showing a typical image of a content and typical images of users;

FIGS. 3A to 3C are diagrams showing typical syntheses of the image of the content and the typical images of the users;

FIG. 4 is a block diagram showing a typical configuration of a communication apparatus employed in the communication system shown in FIG. 1;

FIG. 5 shows a flowchart referred to in an explanation of remote communication processing carried out by the communication apparatus;

FIGS. 6A to 6C are diagrams showing typical behaviors each based on a body language and gesture of a user;

FIG. 7 shows a flowchart referred to in an explanation of first motion control processing;

FIG. 8 shows a flowchart referred to in an explanation of second motion control processing;

FIG. 9 shows a flowchart referred to in an explanation of third motion control processing; and

FIG. 10 is a block diagram showing a typical configuration of a general-purpose personal computer.

### DETAILED DESCRIPTION OF THE PREFERRED EMBODIMENTS

Before preferred embodiments of the present invention are explained, relations between disclosed inventions and the embodiments are explained in the following comparative description. Even if there is an embodiment described in this specification but not included in the following comparative description as an embodiment corresponding to an invention, such an embodiment is not to be interpreted as an embodiment not corresponding to an invention. Conversely, an embodiment included in the following comparative description as an embodiment corresponding to a specific invention is not to be interpreted as an embodiment not corresponding to an invention other than the specific invention.

In addition, the following comparative description is not to be interpreted as a comprehensive description covering all inventions disclosed in this specification. In other words, the following comparative description by no means denies existence of inventions disclosed in this specification but not included in claims as inventions for which a patent application is filed. That is to say, the following comparative description by no means denies existence of inventions to be included in a separate application for a patent, included in an amendment to this specification, or added in the future.

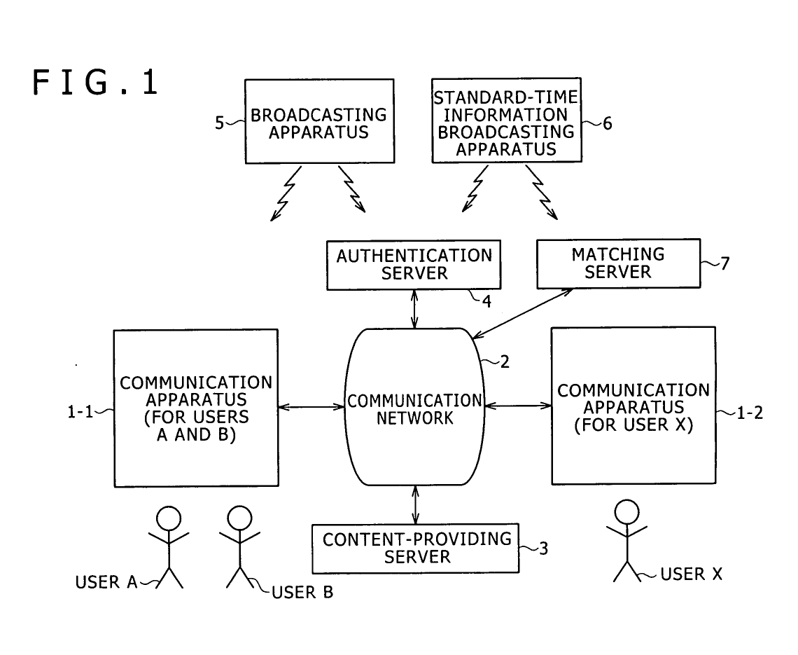

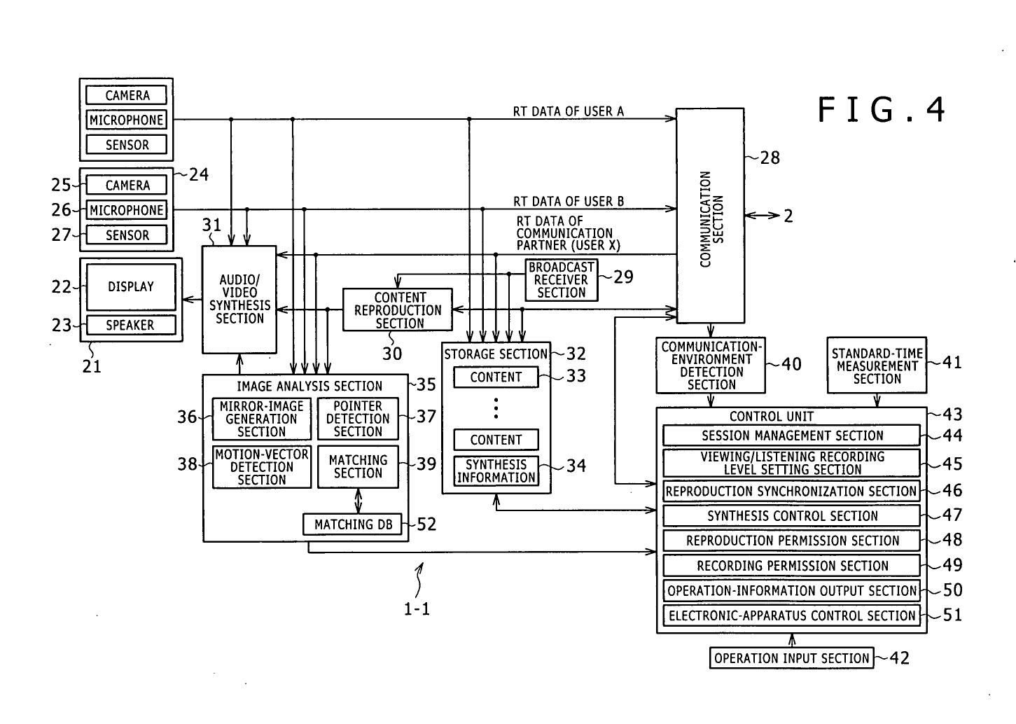

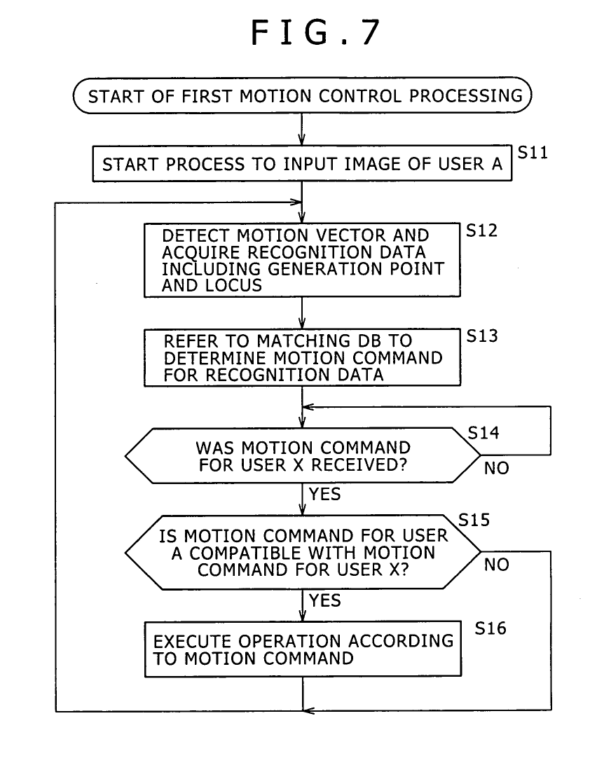

An information-processing apparatus (such as a communication apparatus 1-1 shown in FIG. 1 for carrying out first motion control processing represented by a flowchart shown in FIG. 7) according to an embodiment of the present invention includes:
input means (such as an input section 24 shown in FIG. 4) for carrying out an operation to take an image of a user and inputting a user image obtained as a result of the operation to take the image;
detection means (such as a motion-vector detection section 38 shown in FIG. 4) for carrying out an operation to detect a behavior of the user from the user image and generating behavior information (an example of the information is recognition data including a motion vector, its generation point, and its locus) as a result of the operation to detect the behavior;
generation means (such as a matching section 39 shown in FIG. 4) for generating a first command corresponding to the behavior information;
determination means (such as a control section 43 shown in FIG. 4) for carrying out a process to determine a relation between the first command and a second command received from another information-processing apparatus (such as a communication apparatus 1-2 shown in FIG. 1) as a command corresponding to a behavior of another user operating the other information-processing apparatus; and
control means (such as an electronic-apparatus control section 51 shown in FIG. 4) for controlling execution of processing corresponding to a result of the process carried out by the determination means.

An information-processing apparatus according to another embodiment of the present invention further has reproduction means (such as a content reproduction section 30 shown in FIG. 4) for reproducing content data common to the information-processing apparatus and another information-processing apparatus synchronously with the other information-processing apparatus.

An information-processing method according to a further embodiment of the present invention includes the steps of:
taking an image of a user operating an apparatus used for adoption of the information-processing method and inputting a user image obtained as a result of the operation to take the image (such as a step S11 of the flowchart shown in FIG. 7);
detecting a behavior of the user from the user image and generating behavior information as a result of the operation to detect the behavior (such as a step S12 of the flowchart shown in FIG. 7);
generating a first command corresponding to the behavior information (such as a step S13 of the flowchart shown in FIG. 7);
determining a relation between the first command and a second command received from another information-processing apparatus as a command corresponding to a behavior of another user operating the other information-processing apparatus (such as a step S15 of the flowchart shown in FIG. 7); and
controlling execution of processing corresponding to a result of the process carried out at the determination step (such as a step S16 of the flowchart shown in FIG. 7).

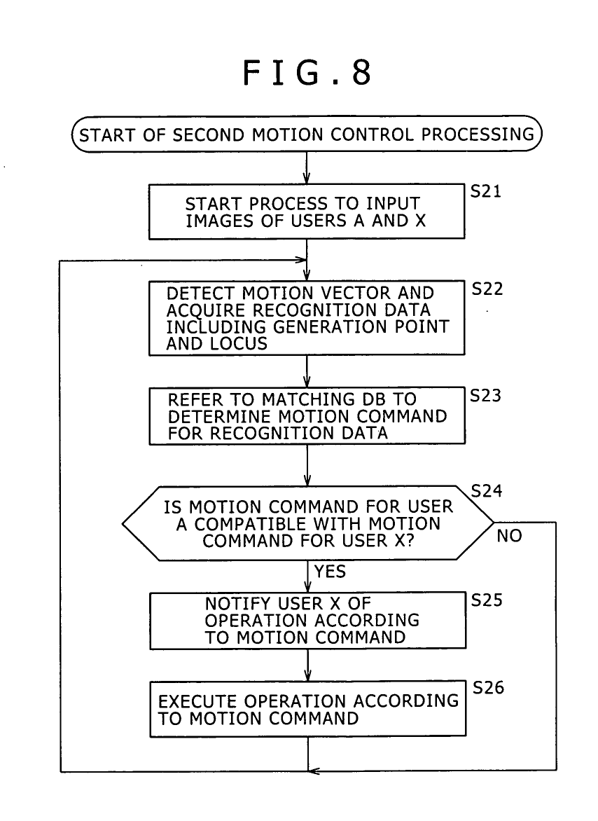

An information-processing apparatus (such as the communication apparatus 1-1 shown in FIG. 1 for carrying out second motion control processing represented by a flowchart shown in FIG. 8) according to a still further embodiment of the present invention includes:
input means (such as the input section 24 shown in FIG. 4) for carrying out an operation to take an image of a user operating the information-processing apparatus and inputting a user image obtained as a result of the operation to take the image;
receiver means (such as a communication section 28 shown in FIG. 4 as a section for carrying a process at a step S21 of the flowchart shown in FIG. 8) for receiving a second user image transmitted by another information-processing apparatus (such as the communication apparatus 1-2 shown in FIG. 1) by way of a network as an image of another user operating the other information-processing apparatus;
detection means (such as the motion-vector detection section 38 shown in FIG. 4) for carrying out an operation to detect a behavior of the user from the first user image and generating first behavior information (an example of the information is recognition data including a motion vector, its generation point, and its locus) as a result of the operation to detect the behavior of the user as well as carrying out an operation to detect a behavior of the other user from the second user image and generating second behavior information of the other user as a result of the operation to detect the behavior of the other user;
generation means (such as the matching section 39 shown in FIG. 4) for generating a first command corresponding to the first behavior information of the user and a second command corresponding to the second behavior information of the other user;
determination means (such as the control section 43 shown in FIG. 4) for carrying out a process to determine a relation between the first and second commands;
communication means (such as the communication section 28 shown in FIG. 4 as a section for carrying a process at a step S25 of the flowchart shown in FIG. 8) for informing the other information-processing apparatus of a result of the process carried out by the determination means through the network; and
control means (such as the electronic-apparatus control section 51 shown in FIG. 4) for controlling execution of processing corresponding to a result of the process carried out by the determination means.

An information-processing apparatus according to a still further embodiment of the present invention further has reproduction means (such as the content reproduction section 30 shown in FIG. 4) for reproducing content data common to the information-processing apparatus and another information-processing apparatus synchronously with the other information-processing apparatus.

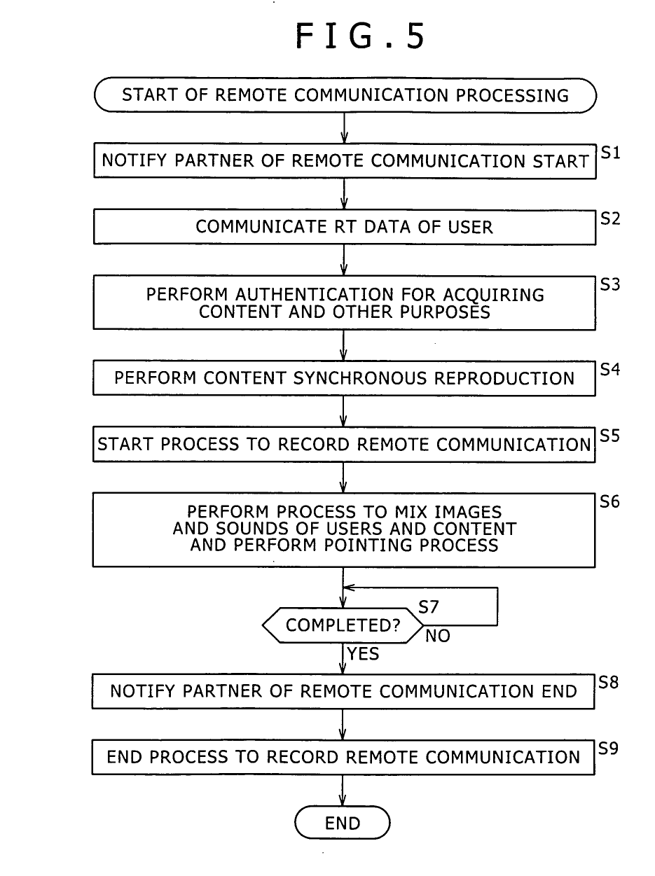

An information-processing method according to a still further embodiment of the present invention includes the steps of:
taking an image of a user operating an apparatus used for adoption of the information-processing method and inputting a first user image obtained as a result of the operation to take the image (such as a step S2 of a flowchart shown in FIG. 5);
receiving a second user image transmitted by another information-processing apparatus by way of a network as an image of another user operating the other information-processing apparatus (such as a step S21 of the flowchart shown in FIG. 8);
detecting a behavior of the user from the first user image and generating first behavior information as a result of the operation to detect the behavior of the user as well as carrying out an operation to detect a behavior of the other user from the second user image and generating second behavior information of the other user as a result of the operation to detect the behavior of the other user (such as a step S22 of the flowchart shown in FIG. 8);
generating a first command corresponding to the first behavior information of the user and a second command corresponding to the second behavior information of the other user (such as a step S23 of the flowchart shown in FIG. 8);
determining a relation between the first and second commands (such as a step S24 of the flowchart shown in FIG. 8);
informing the other information-processing apparatus of a result of the process carried out at the determination step through the network (such as a step S25 of the flowchart shown in FIG. 8); and
controlling execution of processing corresponding to a result of the process carried out at the determination step (such as a step S26 of the flowchart shown in FIG. 8).

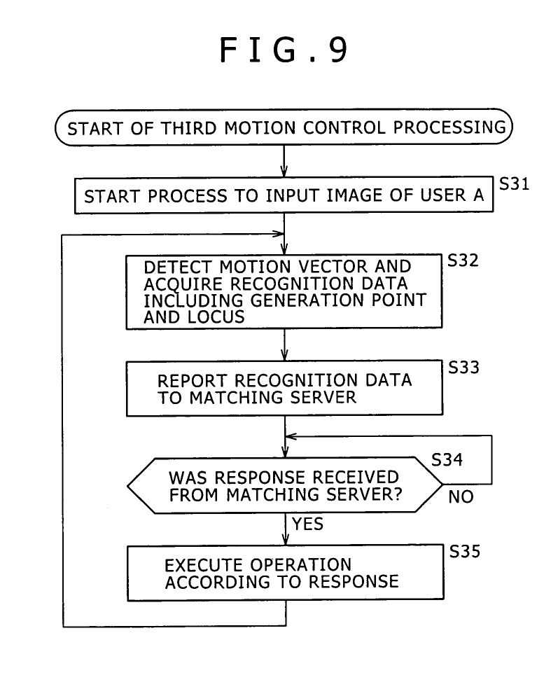

An information-processing apparatus (such as the communication apparatus 1-1 shown in FIG. 1 for carrying out third motion control processing represented by a flowchart shown in FIG. 9) according to a still further embodiment of the present invention includes:
input means (such as the input section 24 shown in FIG. 4) for carrying out an operation to take an image of a user and inputting a user image obtained as a result of the operation to take the image;
detection means (such as the motion-vector detection section 38 shown in FIG. 4) for carrying out an operation to detect a behavior of the user from the user image and generating first behavior information (an example of the information is recognition data including a motion vector, its generation point, and its locus) as a result of the operation to detect the behavior;
notification means (such as the communication section 28 shown in FIG. 4 as a section for carrying a process at a step S33 of the flowchart shown in FIG. 9) for notifying a predetermined server of the first behavior information through a network;
receiver means (such as the communication section 28 shown in FIG. 4 as a section for carrying a process at a step S34 of the flowchart shown in FIG. 9) for receiving a determination result transmitted by the predetermined server in response to the first behavior information transmitted by the notification means to the predetermined server as a determination result on a state of a relation with second behavior information received by the predetermined server from another information-processing apparatus (such as the communication apparatus 1-2 shown in FIG. 1); and
control means (such as the electronic-apparatus control section 51 shown in FIG. 4) for controlling execution of processing corresponding to the determination result received by the receiver means.

An information-processing apparatus according to a still further embodiment of the present invention further has content reproduction means (such as the content reproduction section 30 shown in FIG. 4) for reproducing content data common to the information-processing apparatus and another information-processing apparatus synchronously with the other information-processing apparatus.

An information-processing method according to a still further embodiment of the present invention includes the steps of:
taking an image of a user used for adoption of the information-processing method and inputting a user image obtained as a result of the operation to take the image (such as a step S31 of the flowchart shown in FIG. 9);
carrying out an operation to detect a behavior of the user from the user image and generating first behavior information as a result of the operation to detect the behavior (such as a step S32 of the flowchart shown in FIG. 9);
notifying a predetermined server of the first behavior information by way of a network (such as a step S33 of the flowchart shown in FIG. 9);
receiving a determination result transmitted by the predetermined server in response to the first behavior information transmitted in a process carried out at the notification step to the predetermined server as a determination result on a state of a relation with second behavior information received by the predetermined server from another information-processing apparatus (such as a step S34 of the flowchart shown in FIG. 9); and
controlling execution of processing corresponding to the determination result received in a process carried out at the receiver step (such as a step S35 of the flowchart shown in FIG. 9).

It is to be noted that relations between recording medium for recording a program according to an embodiment of the present invention and concrete implementations in the embodiments are the same as the relations described above as relations between the information-processing methods and concrete implementations in the embodiments. By the same token, relations between programs each provided in accordance with an embodiment of the present invention and concrete implementations in the embodiments are the same as the relations described above as relations between the information-processing methods and concrete implementations in the embodiments. Thus, the relations between recording medium and concrete implementations in embodiments as well as the relations between programs and concrete implementations in embodiments are not explained.

The embodiments of the present invention are explained in detail by referring to diagrams as follows.

FIG. 1 is a diagram showing a typical configuration of a communication system according to an embodiment of the present invention. In this communication system, a communication apparatus 1-1 is connected to another communication apparatus 1 through a communication network 2. In the case of the typical configuration shown in FIG. 1, a communication apparatus 1-2 serves as the other communication apparatus 1. The communication apparatus 1-1 and 1-2 exchange images of their users as well as user voices accompanying the images with each other in a way similar to the so-called television telephone. In addition, the communication apparatus 1-1 reproduces a content common to the communication apparatus 1-1 and 1-2 synchronously with the communication apparatus 1-2. By displaying a common content in this way, remote communication between users is supported. Examples of the common content are moving and still images of a program content obtained as a result of receiving a television broadcast, the content of an already acquired movie or the like obtained by downloading or another process, and a private content exchanged between users. In the following descriptions, the communication apparatus 1-1 and 1-2 are each referred to simply as the communication apparatus 1 in case it is not necessary to distinguish the communication apparatus 1-1 and 1-2 from each other.

The communication apparatus 1 can be utilized by a plurality of users at the same time. In the case of the typical configuration shown in FIG. 1, for example, users A and B utilize the communication apparatus 1-1 whereas a user X utilizes the communication apparatus 1-2.

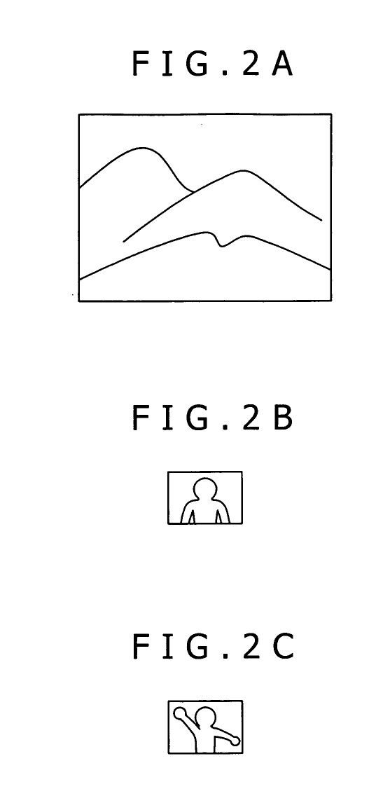

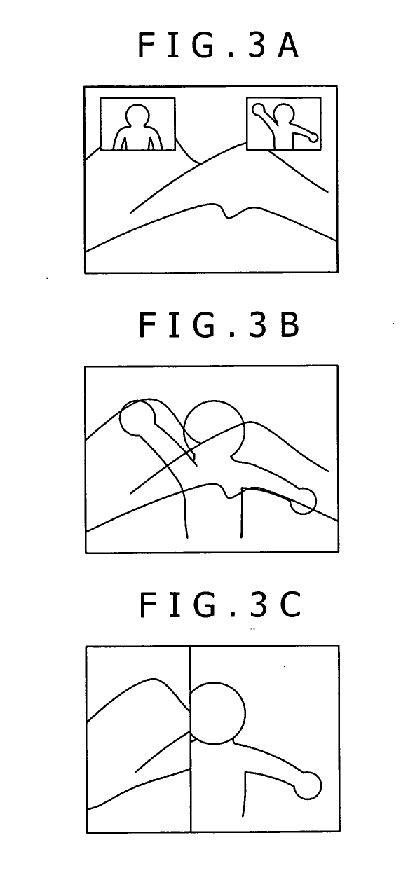

As an example, an image of a common content is shown in FIG. 2A. An image taken by the communication apparatus 1-1 is an image of the user A like one shown in FIG. 2B. On the other hand, an image taken by the communication apparatus 1-2 is an image of the user X like one shown in FIG. 2C. In this case, a display unit 22 employed in the communication apparatus 1-1 as shown in FIG. 4 displays a picture-in-picture screen like one shown in FIG. 3A, a cross-fade screen like one shown in FIG. 3B, or a wipe screen like one shown in FIG. 3C. In either case, the image of the common content and the images of the users are superposed on each other.

It is to be noted that, on the picture-in-picture display like the one shown in FIG. 3A, the images of the users are each superposed on the image of the common content as a small screen. The position and size of each of the small screens can be changed in an arbitrary manner. In addition, instead of displaying the images of both the users, that is, instead of displaying the image of the user A itself and the image of the user X serving as a communication partner of the user A, only the image of either of the users can be displayed. Furthermore, the so-called αblending technique can be adopted as a method whereby the image of the common content is made visible through the transparent small screens for the images of the users.

The cross-fade screen like the one shown in FIG. 3B adopts the αblending technique whereby the image of the common content is made visible through the transparent screen for the image of a user, who can be the user A or X. This cross-fade screen can be used for example when the user points to an arbitrary position or area on the image of the common content.

In the wipe screen like the one shown in FIG. 3C, the image of a user appears on the screen while moving in a certain direction, gradually covering the image of the common content.

The technique to synthesize the image of a common content with the images of users can be changed from time to time. In addition, the image of a common content and the images of users can be displayed by adoption of a method other than the techniques described above.

A state of synthesizing an image of a content with images of users as well as synthesizing sounds of a content with voices of the users is recorded as synthesis information 34 in a storage section 32 employed in the communication apparatus 1-1 as shown in FIG. 4. The synthesis information 34 includes information indicating which of the picture-in-picture technique, the cross-fade technique, and the wipe screen technique is adopted; the position and size of each small screen in the case of the picture-in-picture technique adopted as the synthesis method; the degree of αblending transparency in the case of the cross fade technique adopted; a ratio of volumes; and the like.

Refer back to FIG. 1. The communication network 2 is a broadband data communication network represented by typically the Internet. At a request made by the communication apparatus 1, a content-providing server 3 supplies a content to the communication apparatus 1 by way of the communication network 2. Before the user of the communication apparatus 1 can utilize the communication system, an authentication server 4 authenticates the user. In addition, the authentication server 4 also carries out an accounting process and other processing for a successfully authenticated user.

A broadcasting apparatus 5 is a unit for transmitting a content, which is typically a program of a television broadcast or the like. Thus, the communication apparatus 1 are capable of receiving and reproducing the content from the broadcasting apparatus 5 in a synchronous manner. It is to be noted that the broadcasting apparatus 5 is capable of transmitting a content to the communication apparatus 1 by radio or wire communication. In addition, the broadcasting apparatus 5 may also transmit a content to the communication apparatus 1 by way of the communication network 2.

A standard-time information broadcasting apparatus 6 is a unit for supplying information on a standard time to the communication apparatus 1. The standard time information is used for adjusting a standard time measured by a standard-time measurement section 41, which is employed in each of the communication apparatus 1 as shown in FIG. 4 to serve as a clock. The standard time measured by a clock can be typically the world or Japanese standard time. It is to be noted that the standard-time information broadcasting apparatus 6 is capable of transmitting the information on a standard time to the communication apparatus 1 by radio or wire communication. In addition, the standard-time information broadcasting apparatus 6 may also transmit the information on a standard time to the communication apparatus 1 by way of the communication network 2.

A matching server 7 is a unit for evaluating a matching state between recognition data showing a motion vector and other quantities corresponding to gestures and body language of a user operating the communication apparatus 1-1 and recognition data showing a motion vector and other quantities corresponding to gestures and body language of a user operating the communication apparatus 1-2. The matching server 7 transmits a result of the evaluation to the communication apparatus 1-1 and 1-2.

Next, a typical configuration of the communication apparatus 1-1 is explained in detail by referring to FIG. 4.

An output section 21 employed in the communication apparatus 1-1 includes a display unit 22 and a speaker 23. The output section 21 displays an image corresponding to a video signal received from an audio/video synthesis section 31 on the display unit 22 and outputs a sound corresponding to an audio signal received from the audio/video synthesis section 31 to the speaker 23.

An input section 24 includes a camera 25, a microphone 26, and a sensor 27. The camera 25 is a component for taking an image (including a moving image) of the user. The camera 25 has a function for measuring camera-to-subject distance. The microphone 26 is a component for collecting voices and sounds. The sensor 27 is a component for detecting information on an environment surrounding the user. The information on the environment includes the brightness, the ambient temperature, and the humidity. The input section 24 outputs the acquired moving image, voices/sounds, and information on the environment to a communication section 28 and a storage section 32 as RT (Real Time) data of the user. In addition, the input section 24 also outputs the acquired user image and user voices to the audio/video synthesis section 31. The input section 24 also outputs the acquired user image to an image analysis section 35. It is to be noted that a plurality of input sections 24 can also be provided, being oriented toward a plurality of respective users. In the case of the communication apparatus 1-1 shown in FIG. 4, for example, two input sections 24 are provided, being oriented toward the two users A and B shown in FIG. 1.

The communication section 28 is a unit for transmitting real-time data input by the input section 24 as data of the users A and/or B to the communication apparatus 1-2 serving as a communication partner by way of the communication network 2 and receiving real-time data of the user X from the communication apparatus 1-2. The communication section 28 supplies the real-time data of the user X to the audio/video synthesis section 31, the storage section 32, and the image analysis section 35. In addition, the communication section 28 also receives a content transmitted by the communication apparatus 1-2 or the content-providing server 3 by way of the communication network 2 and supplies the content to a content reproduction section 30 and the storage section 32. The communication section 28 transmits a content 33 and operation information to the communication apparatus 1-2 by way of the communication network 2. The content 33 is a content read out from the storage section 32 and the operation information is information generated by an operation-information output section 50.

A broadcast receiver section 29 is a unit for receiving a television broadcast signal broadcasted by the broadcasting apparatus 5 and supplying a broadcasted program conveyed by the signal as a content to the content reproduction section 30. The content reproduction section 30 is a unit for reproducing a content, which is a broadcasted program received by the broadcast receiver section 29. The reproduced content may also a content received by the communication section 28 or a content read out from the storage section 32. The content reproduction section 30 supplies a sound and image of the reproduced content to the audio/video synthesis section 31 and the image analysis section 35.

The audio/video synthesis section 31 is a unit for synthesizing an image received from the content reproduction section 30 as the image of a content, an image of the user, and an image used for outputting an OSD (On Screen Display) by adoption of the αblending technique or the like, and supplying a video signal obtained as a result of the synthesis to the output section 21. In addition, the audio/video synthesis section 31 is also a unit for synthesizing a sound received from the content reproduction section 30 as the sound of a content and a voice of the user and supplying an audio signal obtained as a result of the synthesis to the output section 21.

The storage section 32 is a unit for storing real-time data and contents. The stored real-time data includes data received from the input section 24 as real-time data of a user such as the user A and data received from the communication section 28 as real-time data of the user X serving as a communication partner. The stored contents include a content received by the broadcast receiver section 29 as a broadcasted program and a content received from the communication section 28. The storage section 32 is also a unit for storing synthesized information 34 generated by a synthesis control section 47.

The image analysis section 35 is a unit for analyzing the brightness and luminance of an image and supplying the result of the analysis to the synthesis control section 47. The analyzed image can be the image of a content received from the content reproduction section 30 or an image of a user. The image of a user may also be an image received from the communication apparatus 1-2. A mirror-image generation section 36 employed in the image analysis section 35 is a unit for generating the mirror image of an image of a user. The image of a user can also be an image received from the communication apparatus 1-2. A pointer detection section 37 employed in the image analysis section 35 is a unit for detecting a wrist of a user or the tip of a finger thereof from an image of the user on the basis of information such as a motion vector detected by a motion-vector detection section 38 as the motion vector of the user. The image of a user may also be an image received from the communication apparatus 1-2. The wrist or the tip of the finger is used by the user as a pointer pointing to a desired position. It is to be noted that, if real-time data input by the input section 24 includes data of a plurality of users, a plurality of pointers is detected and associated with the users.

The motion-vector detection section 38 is a unit for detecting a motion vector showing a behavior of a user from the image of the user and recognizing its generation point and locus. The image of a user may also be an image received from the communication apparatus 1-2. A result of the recognition is referred to hereafter as recognition data. A matching section 39 is a unit for identifying a motion command corresponding to the recognition data received from the motion-vector detection section 38 with reference to a matching DB (database) 52 and outputting the command to the control section 43.

A communication-environment detection section 40 is a unit for monitoring a communication environment with the communication apparatus 1-2 through the communication section 28 and the communication network 2 and outputting a result of the monitoring to the control section 43. The communication environment includes a communication rate and a communication delay time. A standard-time measurement section 41 is a unit for adjusting a standard time measured by itself on the basis of a standard time information received from the standard-time information broadcasting apparatus 6 and supplying the adjusted standard time to the control section 43. An operation input section 42 is typically a remote controller for accepting an operation carried out by the user and issuing a command corresponding to the operation to the control section 43.

The control section 43 is a unit for controlling other components of the communication apparatus 1-1 on the basis of information such as an operation signal received by the operation input section 42 as a an operation carried out by the user and a motion command received from the image analysis section 35. The control section 43 includes a session management section 44, a viewing/listening recording level setting section 45, a reproduction synchronization section 46, the aforementioned synthesis control section 47, a reproduction permission section 48, a recording permission section 49, the operation-information output section 50 mentioned above, and the electronic-apparatus control section 51 cited above. It is to be noted that, in the typical configuration shown in FIG. 4, control lines used for outputting control commands from the control section 43 to other components of the communication apparatus 1-1 are omitted.

The session management section 44 is a unit for controlling a process carried out by the communication section 28 to connect the communication apparatus 1-1 to other apparatus such as the communication apparatus 1-2, the content-providing server 3, and the authentication server 4 through the communication network 2. The viewing/listening recording level setting section 45 is a unit for determining whether or not real-time data acquired by the input section 24 as data of the user A or other users can be reproduced and recorded by the communication apparatus 1-2, which serves as the communication partner, on the basis of a setting operation received from the user. If the real-time data is determined to be data that can be recorded by the communication apparatus 1-2, the maximum number of times the data can be recorded is set and transmitted to the communication apparatus 1-2 from the communication section 28. The reproduction synchronization section 46 is a unit for controlling the broadcast receiver section 29 and the content reproduction section 30 to reproduce a content common to the communication apparatus 1-1 synchronously with the communication apparatus 1-2, which serves as the communication partner.

The synthesis control section 47 is a unit for controlling the audio/video synthesis section 31 on the basis of an analysis result produced by the image analysis section 35 to synthesize an image of a content with images of users and synthesize a voice of a content with voices of users in accordance with a set operation received from the user. The reproduction permission section 48 is a unit for outputting a determination result as to whether or not a content can be reproduced on the basis of information such as a license attached to the content and controlling the content reproduction section 30 on the basis of the result of the determination. The recording permission section 49 is a unit for outputting a determination result as to whether or not real-time data of a user and a content can be recorded on the basis of setting of the communication partner and a license attached to the content and controlling the storage section 32 on the basis of the result of the determination. The operation-information output section 50 is a unit for generating operation information for an operation carried out by the user and transmitting the information to the communication apparatus 1-2 serving as the communication partner by way of the communication section 28. The operation carried out by the user can be an operation to change a channel to receive a television broadcast, an operation to start a process to reproduce a content, an operation to end a process to reproduce a content, an operation to reproduce a content in a fast-forward process, or another operation. The operation information includes a description of the operation and a time at which the operation is carried out. Details of the operation information will be described later. The operation information is used in synchronous reproduction of a content.

The electronic-apparatus control section 51 is a unit for controlling a predetermined electronic apparatus, which is connected to the communication apparatus 1-1 by wire or radio communication, on the basis of a motion command received from the image analysis section 35. Examples of the predetermined electronic apparatus are an illumination apparatus and an air-conditioning apparatus, which are not shown in the figure.

The matching database 52 is used for storing in advance information such as a table showing relations between recognition data and motion commands. As described earlier, the recognition data includes a motion vector of a user detected by the motion vector detection section 38 as well as a generation point and locus of the motion vector. It is to be noted that the user is allowed to arbitrarily add a relation between recognition data and a motion command to the existing table. For example, the user can add a relation between recognition data recorded in meta data of a content to be reproduced and a motion command to the table already recorded in the matching database 52. In this way, the image analysis section 35 will read out the added relation later on from the table.

It is to be noted that, since a detailed typical configuration of the communication apparatus 1-2 is the same as that of the communication apparatus 1-1 shown in FIG. 4, no special explanation of the detailed typical configuration of the communication apparatus 1-2 is given.

Next, remote communication processing carried out by the communication apparatus 1-1 to communicate with the communication apparatus 1-2 is explained by referring to a flowchart shown in FIG. 5 as follows.

The remote communication processing to communicate with the communication apparatus 1-2 is started when an operation to start the remote communication is carried out on the operation input section 42 and an operation signal corresponding to the operation is supplied by the operation input section 42 to the control section 43.

The flowchart shown in the figure begins with a step S1 at which the communication section 28 establishes a connection with the communication apparatus 1-2 through the communication network 2 on the basis of control executed by the session management section 44 in order to notify the communication apparatus 1-2 that a remote communication is started. In response to this notification, the communication apparatus 1-2 returns an acknowledgement of the notification to the communication apparatus 1-1 as an acceptance of the start of the remote communication.

Then, at the next step S2, the communication section 28 starts transmitting real-time data of the user A and other real-time data, which are received from the input section 24, to the communication apparatus 1-2 by way of the communication network 2 on the basis of control executed by the control section 43. The communication section 28 also starts receiving real-time data of the user X from the communication apparatus 1-2. Images included in the real-time data of the user A and the other real-time data as well as images included in real-time data received from the communication apparatus 1-2 as the real-time data of the user X are supplied to the audio/video synthesis section 31. By the same token, voices included in the real-time data of the user A and the other real-time data as well as voices included in the real-time data of the user X are also supplied to the audio/video synthesis section 31.

Then, at the next step S3, the communication section 28 establishes a connection with the authentication server 4 through the communication network 2 on the basis of control, which is executed by the session management section 44, in order to carry out an authentication process for acquiring a content. After the authentication process has been completed successfully, the communication section 28 makes an access to the content-providing server 3 through the communication network 2 in order to acquire a content specified by the user. At that time, the communication apparatus 1-2 carries out the same processes as the communication apparatus 1-1 to obtain the same content.

It is to be noted that, if the specified content is a content to be received as a television broadcast or an already acquired content stored in the storage section 32 and ready for reproduction, the process of the step S3 can be omitted.

Then, at the next step S4, the content reproduction section 30 starts a process to reproduce the content synchronized with the communication apparatus 1-2 on the basis of control executed by the reproduction synchronization section 46. Subsequently, at the next step S5, the storage section 32 starts a remote communication recording process. To put it concretely, the storage section 32 starts a process to record the content, the reproduction of which has been started, the images and voices included in the real-time data of the user A and the other real-time data as well as the images and voices included in the real-time data of the user X, and synthesis information 34 generated by the synthesis control section 47 as information on the state of synthesis of the images and the voices.

Then, at the next step S6, in accordance with control executed by the synthesis control section 47, the audio/video synthesis section 31 synthesizes images and voices of the reproduced content, the images and voices included in the real-time data of the user A and the other real-time data as well as the images and voices included in the real-time data of the user X, by adoption of any one of the methods shown in FIGS. 3A to 3C. The audio/video synthesis section 31 then supplies video and audio signals obtained as a result of the synthesis to the output section 21. The output section 21 displays an image corresponding to the supplied video signal and generates a sound corresponding to the supplied audio signal. At this stage, exchanges of images and voices between the users as well as the synchronous reproduction of the content have been started.

In addition, at the step S6, concurrently with processes carried out by the audio/video synthesis section 31 and other sections, the pointer detection section 37 employed in the image analysis section 35 detects a pointer of the user A and other pointers on the basis of images included in the real-time data of the user A and the other real-time data. The pointer detection section 37 then carries out a pointing process to display the pointers on the screen.

Then, at the next step S7, the control section 43 produces a determination result as to whether or not the user has carried out an operation to make a request for termination of the remote communication. The control section 43 carries out the process of this step repeatedly until the user carries out such an operation. As the result of the determination indicates that the user has carried out an operation to make a request for termination of the remote communication, the flow of the processing goes on to a step S8.

At the step S8, the communication section 28 establishes a connection with the communication apparatus 1-2 through the communication network 2 on the basis of control, which is executed by the session management section 44, in order to notify the communication apparatus 1-2 that a remote communication has been ended. In response to this notice, the communication apparatus 1-2 returns an acknowledgement of the notification to the communication apparatus 1-1 as an acceptance of the termination of the remote communication.

Then, at the next step S9, the storage section 32 terminates the communication-recording process. In this way, when a next remote communication is carried out later on, it is possible to utilize the stored data of the terminated remote communication. The stored data of the terminated remote communication includes the reproduced content, the images and voices included in the real-time data of the user A and the other real-time data as well as the images and voices included in the real-time data of the user X, and the synthesis information 34.

The processing of the remote communication between the communication apparatus 1-1 and the communication apparatus 1-2 has been explained above.

In accordance with the above description, the communication apparatus 1-1 serves as a master apparatus while the communication apparatus 1-2 serves as a slave apparatus operating to follow the master. However, the master-slave relation between the communication apparatus 1-1 and 1-2 can be reversed and changed from time to time. That is to say, the communication apparatus 1-2 may also serve as a master apparatus while the communication apparatus 1-1 serves as a slave apparatus operating to follow the master.

In addition, in accordance with the above description, only one communication apparatus 1, that is, only the communication apparatus 1-2, serves as a slave apparatus operating to follow the communication apparatus 1-1. However, a plurality of communication apparatus 1 may each serve as a slave apparatus operating to follow the communication apparatus 1-1 as well. In addition, any of the communication apparatus 1 may serve as a master apparatus at any time and the master-slave relation can be changed from time to time.

The following description explains an outline of a motion control process carried out concurrently with the process carried out at the step S4 of the flowchart representing the remote communication processing described above as a process to reproduce a content synchronously with another communication apparatus. In this motion control process, the behavior of the user A operating the communication apparatus 1-1 is detected as a behavior based on a body language and gesture of the user A and, then, a motion command corresponding to the behavior is determined. In addition, the behavior of the user X operating the communication apparatus 1-2 is also detected as a behavior based on a body language and gesture of the user X and, then, a motion command corresponding to the behavior is determined as well. Based on the matching condition between the motion commands for users A and X, the communication apparatus 1-1 and 1-2 each perform a predetermined process.

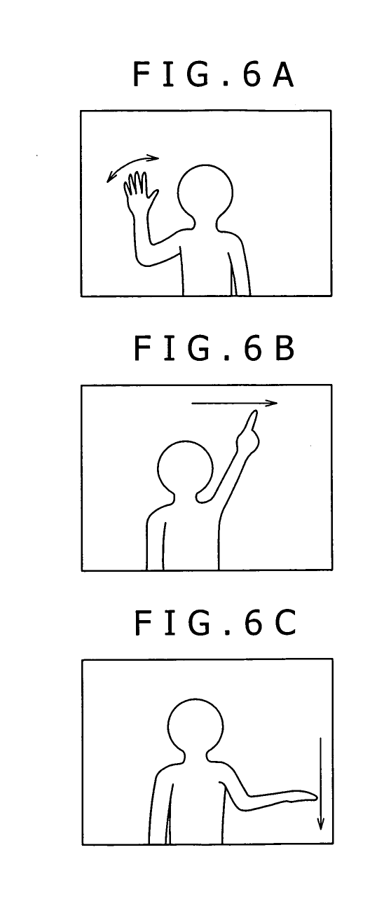

FIGS. 6A to 6C are diagrams showing behaviors detected by the motion-vector detection section 38 in the motion control process as typical behaviors of the users A, X, and any other user. In the behavior shown in FIG. 6A, a user raises its hand, exposes the palm of the hand, and waves the hand to the right and the left. In the behavior shown in FIG. 6B, a user raises its hand and moves the tip of its forefinger in the horizontal direction. In the behavior shown in FIG. 6C, a user stretches a hand to the side and moves down the hand. The motion-vector detection section 38 detects the behaviors as recognition data including a motion vector, its generation point, and its locus.

Motion commands corresponding to the recognition data typically include a command to switch a still image displayed as a content to another image, a command to switch a piece of music reproduced as a content to other music, a command to switch a channel of a broadcast program reproduced as a content to another channel, a command to change the size of a small screen superposed on an image displayed as a content, a command to end a session, a command to execute a screen effect such as vibration of the screen, a command to adjust the brightness/darkness of an illumination apparatus, a command to adjust a set temperature of an air-conditioning apparatus, and a command to show a consent. These commands are listed typically in a table stored in the matching database 52.

It is to be noted that the communication apparatus 1-1 and 1-2 carry out the same predetermined processing on the basis of a matching condition, which means not only a case in which a motion command for the user A matches a motion command for the user X, but also a case in which a motion command for the user A is different from a motion command for the user X but the different motion commands form a command combination determined in advance.

Let us assume for example that the behavior shown in FIG. 6A is recognized from an image of the user A, which is one of the users. As shown in the figure, the behavior is a behavior of waving a hand. As a motion command corresponding to this behavior, the command to end a session is determined. Let us also assume for example that the behavior shown in FIG. 6A is recognized from an image of the user X, which is another user. As shown in the figure, the behavior is a behavior of waving a hand. As a motion command corresponding to this behavior, the command to end a session is determined. In this case, the communication apparatus 1-1 and 1-2 both terminate the session.

Now, let us assume for example that the behavior shown in FIG. 6B is recognized from an image of the user A. As a motion command corresponding to this behavior, the command to change a still image to another is determined. Let us also assume for example that the behavior of nodding a head in a bowing action is recognized from an image of the user X. As a motion command corresponding to this head-nodding behavior, the command to express a consent is determined. In this case, the communication apparatus 1-1 and 1-2 both terminate the session.

The motion control processing is carried out in a mode selected among a cooperation mode, a master-slave mode, and a server mode. One of the three modes can be determined in accordance with specifications of the communication apparatus 1 or selected by the user.

In the cooperation mode, the communication apparatus 1-1 and 1-2 each analyze only an image of its own user to acquire recognition data on the basis of a result of the analysis and determine a motion command corresponding to the recognition data. Then, the communication apparatus 1-1 and 1-2 exchange the motion commands to determine a matching condition of the commands. Processing is finally carried out on the basis of a result of the determination.

In the master-slave mode, any specific one of the communication apparatus 1-1 and 1-2 analyzes the images of both the users A and X to acquire recognition data on the basis of a result of the analysis, determining a motion command corresponding to the recognition data for each of the users A and X. The specific communication apparatus 1 also produces a determination result on the matching state between the motion commands for the users A and X. Then, the specific communication apparatus 1 serving as a master reports a result of the determination to the other communication apparatus 1 serving as a slave so that both the communication apparatus 1-1 and 1-2 are capable of carrying out predetermined processing based on the result of the determination. It is to be noted that the user is allowed to determine which of the communication apparatus 1-1 and 1-2 serves as a master and which apparatus serves as a slave. The user is also allowed to change the master and the slave from time to time.

In the server mode, the communication apparatus 1-1 and 1-2 each analyze only an image of its own user to acquire recognition data on the basis of a result of the analysis. Then, the communication apparatus 1-1 and 1-2 transmit the recognition data to the matching server 7. The matching server 7 determines a motion command corresponding to the recognition data of the user A and a motion command corresponding to the recognition data of the user X. The matching server 7 also produces a determination result on the matching state between the motion commands for the users A and X, reporting the result of the determination to the communication apparatus 1-1 and 1-2 so that both the communication apparatus 1-1 and 1-2 are capable of carrying out predetermined processing based on the result of the determination.

By referring to a flowchart shown in FIG. 7, the following description explains operations carried out by the communication apparatus 1-1 as first motion control processing adopting the cooperation mode.

The flowchart shown in the figure begins with a step S11 at which the image analysis section 35 employed in the communication apparatus 1-1 supplies an image received from the input section 24 as the image of the user A to the motion-vector detection section 38. It is to be noted that the image of the user A can also be supplied to the mirror-image generation section 36 for generating a mirror image, which is then supplied to the motion-vector detection section 38.

Then, at the next step S12, the motion-vector detection section 38 detects a motion vector from the image of the user A to acquire recognition data including a generation point and locus of the motion vector. The motion-vector detection section 38 then supplies the recognition data to the matching section 39. Subsequently, at the next step S13, the matching section 39 refers to the matching database 52 to determine a motion command corresponding to the recognition data acquired by the motion-vector detection section 38 and supplies the motion command to the control section 43.

Then, at the next step S14, the control section 43 produces a determination result as to whether or not the communication section 28 has received a motion command from the communication apparatus 1-2. The control section 43 carries out the process of this step repeatedly until the communication section 38 acquires the motion command. As the result of the determination indicates that the communication section 28 has received the motion command from the communication apparatus 1-2, the flow of the processing goes on to a step S15.

At the step S15, the control section 43 produces a determination result as to whether or not a motion command received from the matching section 39 as the motion command for the user A is compatible with a motion command received by the communication section 28 as the motion command for the user X. To put it concretely, the control section 43 determines whether or not the motion command for the user A matches the motion command for the user X or whether or not the motion command for the user A and the motion command for the user X form a command combination determined in advance even though the commands are different from each other. If the result of the determination indicates that the motion command for the user A is compatible with the motion command for the user X, the flow of the processing goes on to a step S16.

At the step S16, the control section 43 carries out an operation corresponding to the motion command for the user A. To put it concretely, for example, the control section 43 changes a channel used by the broadcast receiver section 29 as a receiver channel to another one, adjusts the volume of a sound generated by the speaker 23 employed in the output section 21, or adjusts the luminance of an illumination apparatus connected to the electronic-apparatus control section 51 of the control section 43 employed in the communication apparatus 1-1. Then, the flow of the processing goes back to the step S12 to repeat the processing described above.

It is to be noted that, if the determination result produced at the step S15 indicates that the motion command for the user A is not compatible with the motion command for the user X, on the other hand, the flow of the processing goes back to the step S12 to repeat the processing described above, skipping the step S16.

The above description has explained the operations carried out by the communication apparatus 1-1 as the first motion control processing adopting the cooperation mode. It is to be noted that, by driving the communication apparatus 1-2 to carry out the same operations as those of the communication apparatus 1-1, the first motion control processing can be performed.

By referring to a flowchart shown in FIG. 8, the following description explains operations carried out by the communication apparatus 1-1 as second motion control processing adopting the master-slave mode. It is to be noted that, in the following description, the communication apparatus 1-1 and 1-2 serve as a master and a slave respectively.

The flowchart shown in the figure begins with a step S21 at which the image analysis section 35 employed in the communication apparatus 1-1 passes on an image received from the input section 24 as the image of the user A and an image received by the communication section 28 from the communication apparatus 1-2 as the image of the user X to the motion-vector detection section 38. It is to be noted that the images of the users A and X can also be supplied to the mirror-image generation section 36, which generates the mirror images of the images of the users A and X. In this case, the mirror-image generation section 36 then supplies the mirror images to the motion-vector detection section 38.

Then, at the next step S22, the motion-vector detection section 38 detects a motion vector from the image of the user A to acquire recognition data including a generation point and locus of the motion vector for the user A. By the same token, the motion-vector detection section 38 detects a motion vector from the image of the user X to acquire recognition data including a generation point and locus of the motion vector for the user X. The motion-vector detection section 38 then supplies the pieces of recognition data to the matching section 39. Subsequently, at the next step S23, the matching section 39 refers to the matching database 52 to determine a motion command corresponding to the recognition data acquired by the motion-vector detection section 38 as the recognition data for the user A and supplies the motion command to the control section 43. By the same token, the matching section 39 refers to the matching database 52 to determine a motion command corresponding to the recognition data acquired by the motion-vector detection section 38 as the recognition data for the user X and supplies the motion command to the control section 43.

Then, at the next step S24, the control section 43 produces a determination result as to whether or not a motion command received from the matching section 39 as the motion command for the user A is compatible with a motion command also received from the matching section 39 as the motion command for the user X. To put it concretely, the control section 43 determines whether or not the motion command for the user A matches the motion command for the user X or whether or not the motion command for the user A and the motion command for the user X form a command combination determined in advance even though the commands are different from each other. If the result of the determination indicates that the motion command for the user A is compatible with the motion command for the user X, the flow of the processing goes on to a step S25.

At the step S25, the control section 43 notifies the communication apparatus 1-2 of an operation corresponding to the motion command for the user A through the communication section 28. Then, at the next step S26, the control section 43 carries out the operation corresponding to the motion command for the user A. To put it concretely, for example, the control section 43 changes a channel used by the broadcast receiver section 29 as a receiver channel to another one, adjusts the volume of a sound generated by the speaker 23 employed in the output section 21, or adjusts the luminance of an illumination apparatus connected to the electronic-apparatus control section 51 of the control section 43 employed in the communication apparatus 1-1. In the mean time, the communication apparatus 1-2 carries out the same operation as that of the communication apparatus 1-1 in accordance with the notification received from the communication apparatus 1-1. Then, the flow of the processing goes back to the step S22 to repeat the processing described above.

It is to be noted that, if the determination result produced at the step S24 indicates that the motion command for the user A is not compatible with the motion command for the user X, on the other hand, the flow of the processing goes back to the step S22 to repeat the processing described above, skipping the steps S25 and S26.

The above description has explained the operations carried out by the communication apparatus 1-1, which serves as the master, as the second motion control processing adopting the master-slave mode. It is to be noted that the communication apparatus 1-2 serving as a slave needs only to transmit real-time data for the user X to the communication apparatus 1-1 and operate in accordance with the notification received from the communication apparatus 1-1.

By referring to a flowchart shown in FIG. 9, the following description explains operations carried out by the communication apparatus 1-1 as third motion control processing adopting the server mode.

The flowchart shown in the figure begins with a step S31 at which the image analysis section 35 employed in the communication apparatus 1-1 supplies an image received from the input section 24 as the image of the user A to the motion-vector detection section 38. It is to be noted that the image of the user A can also be supplied to the mirror-image generation section 36 for generating the mirror image, which is then supplied to the motion-vector detection section 38.

Then, at the next step S32, the motion-vector detection section 38 detects a motion vector from the image of the user A to acquire recognition data including a generation point and locus of the motion vector and supplies the recognition data to the control section 43. Subsequently, at the next step S33, the control section 43 transmits the recognition data received from the motion-vector detection section 38 as recognition data for the user A to the matching server 7 by way of the communication section 28.

In the mean time, the communication apparatus 1-2 also carries out processes similar to those of the steps S31 to S33. Thus, the matching server 7 receives the recognition data for the user A from the communication apparatus 1-1 and the recognition data for the user X from the communication apparatus 1-2.

The matching server 7 determines a motion command corresponding to the recognition data for the user A and a motion command corresponding to the recognition data for the user X. Then, the matching server 7 produces a determination result as to whether or not the motion command for the user A is compatible with the motion command for the user X. To put it concretely, the matching server 7 determines whether or not the motion command for the user A matches the motion command for the user X or whether or not the motion command for the user A and the motion command for the user X form a command combination determined in advance even though the commands are different from each other. If the result of the determination indicates that the motion command for the user A is compatible with the motion command for the user X, the matching server 7 transmits the motion command for the user A and the motion command for the user X to the communication apparatus 1-1 and the communication apparatus 1-2 respectively. If the result of the determination indicates that the motion command for the user A is not compatible with the motion command for the user X, on the other hand, the matching server 7 notifies the communication apparatus 1-1 and the communication apparatus 1-2 of the incompatibility.

Then, at the next step S34, the control section 43 produces a determination result as to whether or not the communication section 28 has received a response from the matching server 7. The control section 43 carries out the process of this step repeatedly until the control section 43 determines that the response from the matching server 7 is received. As the result of the determination indicates that the communication section 28 has received the response from the matching server 7, the flow of the processing goes on to a step S35.

At the step S35, the control section 43 carries out an operation according to the response received from the matching server 7. To put it concretely, if the response received from the matching server 7 is a motion command, the control section 43 carries out an operation according to the motion command. For example, the control section 43 changes a channel used by the broadcast receiver section 29 as a receiver channel to another one, adjusts the volume of a sound generated by the speaker 23 employed in the output section 21, or adjusts the luminance of an illumination apparatus connected to the electronic-apparatus control section 51 of the control section 43 employed in the communication apparatus 1-1. Then, the flow of the processing goes back to the step S32 to repeat the processing described above. If the response received from the matching server 7 is a message indicating that the motion command for the user A is not compatible with the motion command for the user X, on the other hand, the control section 43 does not carry out an operation in particular. Instead, the flow of the processing merely goes back to the step S32 to repeat the processing described above. Also in the communication apparatus 1-2, the control section 43 carries out an operation according to the response received from the matching server 7 in the same way as the communication apparatus 1-1.

The above description has explained the operations carried out by the communication apparatus 1-1 as the third motion control processing adopting the server mode.

In accordance with the first motion control processing to the third motion control processing, which have been described above, the communication apparatus 1-1 and 1-2 carry out processing in dependence on a relation between an operation indicated by a body language and gesture of the user A operating the communication apparatus 1-1 and an operation indicated by a body language and gesture of the user X operating the communication apparatus 1-2. Thus, the degree of harmony between the users A and X as well as the sense of mutual understanding between the users can be enhanced so that smoother remote communication can be expected.

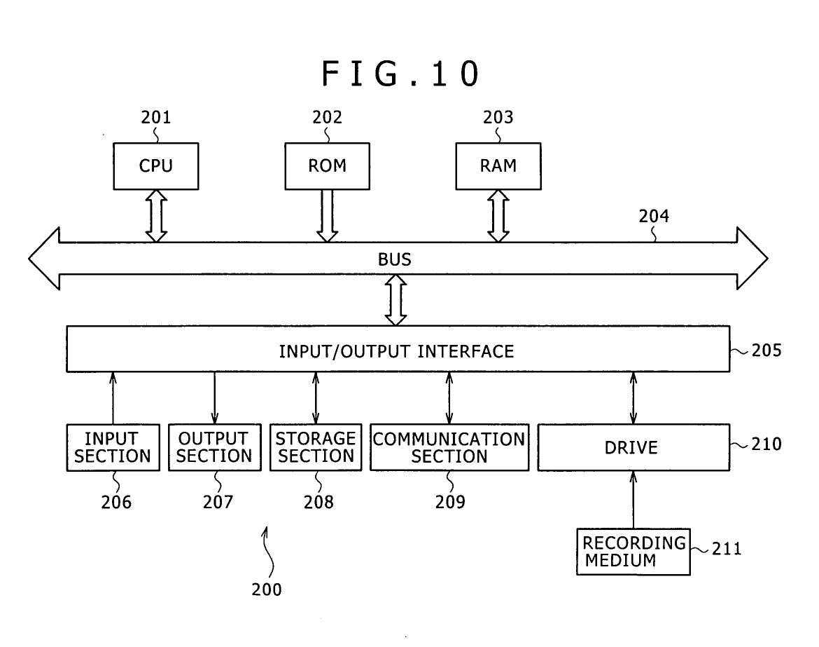

The series of processes carried out by the communication apparatus 1 as described previously can be carried out by hardware and/or execution of software. If the series of processes described above is carried out by execution of software, programs composing the software can be installed into a computer embedded in dedicated hardware, a general-purpose personal computer, or the like from typically a network or a recording medium. By installing a variety of programs into the general-purpose personal computer, the personal computer is capable of carrying out a variety of functions. A typical general-purpose personal computer 200 is shown in FIG. 10.

As shown in the figure, the general-purpose personal computer 200 has a CPU (Central Processing Unit) 201 embedded therein. The CPU 201 is connected to an input/output interface 205 through a bus 204. The bus 204 is also connected to a ROM (Read Only Memory) 202 and a RAM (Random Access Memory) 203.

The input/output interface 205 is connected to an input section 206, an output section 207, a storage section 208, and a communication section 209. Used for receiving a command entered by the user, the input section 206 includes input devices such as a keyboard and a mouse, whereas the output section 207 includes a display unit for displaying an image and a speaker for outputting a generated sound. The storage section 208 is typically a hard-disk drive for storing a variety of programs and various kinds of data. The communication section 209 is a unit for carrying out communication processing with other apparatus through a network represented by the Internet. The input/output interface 205 is also connected to a drive 210 on which a recording medium 211 is mounted. Examples of the recording medium 211 are magnetic disks including a flexible disk, optical disks including a CD-ROM (Compact Disk-Read Only Memory) and a DVD (Digital Versatile Disk), magneto-optical disks including an MD (Mini Disk), and a semiconductor memory.

A program to be executed by the general-purpose personal computer 200 to carry out the processing of the communication apparatus 1 as described above is supplied to the general-purpose personal computer 200 from the recording medium 211 by having the drive 210 read out the program from the recording medium 211 and is then installed in a hard disk embedded in the storage section 208. When the user enters a command to the input section 206 as a command to execute a program already installed in the hard disk embedded in the storage section 208, the CPU 201 issues a CPU command corresponding to the command entered by the user to the storage section 208 as a command to load the program from the hard disk embedded in the storage section 208 into the RAM 203 for execution by the CPU 201.

In this specification, steps of any program represented by a flowchart described above can be carried out not only in a pre-prescribed order along the time axis, but also concurrently or individually.

In addition, in order to carry out processing described above, a program can be executed by one computer or a plurality of computers operating in a distributed-processing environment. Furthermore, a program can also be transferred to a computer at a remote location to be executed by the remote computer.

It is also to be noted that the technical term ‘system’ used in this specification implies the configuration of a confluence including a plurality of apparatus.

In addition, it should be understood by those skilled in the art that a various modifications, combinations, sub-combinations and alterations may occur depending on design requirements and other factors insofar as they are within the scope of the appended claims or the equivalents thereof.

What is claimed is:

1. An information-processing apparatus for communicating an image of a user to an other information-processing apparatus by way of a network, said information-processing apparatus comprising:
input means for carrying out an operation to take an image of a user and inputting a user image obtained as a result of said operation to take said image;
detection means for carrying out an operation to detect a behavior of said user from said user image and generating behavior information as a result of said operation to detect said behavior;
generation means for generating a first command corresponding to said behavior information;
determination means for carrying out a process to determine a relation between said first command and a second command received from said other information-processing apparatus as a command corresponding to a behavior of an other user operating said other information-processing apparatus; and
control means for controlling execution of processing corresponding to a result of said process carried out by said determination means.

2. The information-processing apparatus according to claim 1, said information-processing apparatus further having reproduction means for reproducing content data common to said information-processing apparatus and said other information-processing apparatus synchronously with said other information-processing apparatus.

3. An information-processing method for communicating an image of a user to an other information-processing apparatus by way of a network, said information-processing method comprising the steps of:
taking an image of a user and inputting a user image obtained as a result of said operation to take said image;
detecting a behavior of said user from said user image and generating behavior information as a result of said operation to detect said behavior;
generating a first command corresponding to said behavior information;
determining a relation between said first command and a second command received from said other information-processing apparatus as a command corresponding to a behavior of an other user operating said other information-processing apparatus; and
controlling execution of processing corresponding to a result of said process carried out at said determination step.

4. A recording medium for recording a program for communicating an image of a user to an other information-processing apparatus by way of a network wherein said program comprises the steps of:
taking an image of a user and inputting a user image obtained as a result of said operation to take said image;
detecting a behavior of said user from said user image and generating behavior information as a result of said operation to detect said behavior;
generating a first command corresponding to said behavior information;
determining a relation between said first command and a second command received from said other information-processing apparatus as a command corresponding to a behavior of an other user operating said other information-processing apparatus; and
controlling execution of processing corresponding to a result of said process carried out at said determination step.

5. A program for communicating an image of a user to an other information-processing apparatus by way of a network, said program comprising the steps of:
taking an image of a user and inputting a user image obtained as a result of said operation to take said image;
detecting a behavior of said user from said user image and generating behavior information as a result of said operation to detect said behavior;
generating a first command corresponding to said behavior information;
determining a relation between said first command and a second command received from said other information-processing apparatus as a command corresponding to a behavior of an other user operating said other information-processing apparatus; and
controlling execution of processing corresponding to a result of said process carried out at said determination step.

6. An information-processing apparatus for communicating an image of a user to an other information-processing apparatus by way of a network, said information-processing apparatus comprising:
input means for carrying out an operation to take an image of a user operating said information-processing apparatus and inputting a first user image obtained as a result of said operation to take said image;
receiver means for receiving a second user image transmitted by said other information-processing apparatus by way of said network as an image of an other user operating said other information-processing apparatus;
detection means for carrying out an operation to detect a behavior of said user from said first user image and generating first behavior information as a result of said operation to detect said behavior of said user as well as carrying out an operation to detect a behavior of said other user from said second user image and generating second behavior information of said other user as a result of said operation to detect said behavior of said other user;
generation means for generating a first command corresponding to said first behavior information of said user and a second command corresponding to said second behavior information of said other user;
determination means for carrying out a process to determine a relation between said first and second commands;
communication means for informing said other information-processing apparatus of a result of said process carried out by said determination means through said network; and
control means for controlling execution of processing corresponding to a result of said process carried out by said determination means.

7. The information-processing apparatus according to claim 6, said information-processing apparatus further having reproduction means for reproducing content data common to said information-processing apparatus and said other information-processing apparatus synchronously with said other information-processing apparatus.

8. An information-processing method for communicating an image of a user to an other information-processing apparatus by way of a network, said information-processing method comprising the steps of:
taking an image of a user and inputting a first user image obtained as a result of said operation to take said image;
receiving a second user image transmitted by said other information-processing apparatus by way of said network as an image of an other user operating said other information-processing apparatus;
detecting a behavior of said user from said first user image and generating first behavior information as a result of said operation to detect said behavior of said user as well as carrying out an operation to detect a behavior of said other user from said second user image and generating second behavior information of said other user as a result of said operation to detect said behavior of said other user;
generating a first command corresponding to said first behavior information of said user and a second command corresponding to said second behavior information of said other user;
determining a relation between said first and second commands;
informing said other information-processing apparatus of a result of said process carried out at said determination step through said network; and
controlling execution of processing corresponding to a result of said process carried out at said determination step.

9. A recording medium for recording a program for communicating an image of a user to an other information-processing apparatus by way of a network wherein said program comprises the step of:
taking an image of a user and inputting a first user image obtained as a result of said operation to take said image;
receiving a second user image transmitted by said other information-processing apparatus by way of said network as an image of an other user operating said other information-processing apparatus;
detecting a behavior of said user from said first user image and generating first behavior information as a result of said operation to detect said behavior of said user as well as carrying out an operation to detect a behavior of said other user from said second user image and generating second behavior information of said other user as a result of said operation to detect said behavior of said other user;
generating a first command corresponding to said first behavior information of said user and a second command corresponding to said second behavior information of said other user;
determining a relation between said first and second commands;
informing said other information-processing apparatus of a result of said process carried out at said determination step through said network; and
controlling execution of processing corresponding to a result of said process carried out at said determination step.

10. A program for communicating an image of a user to an other information-processing apparatus by way of a network, said program comprising the steps of:
taking an image of a user and inputting a first user image obtained as a result of said operation to take said image;
receiving a second user image transmitted by said other information-processing apparatus by way of said network as an image of an other user operating said other information-processing apparatus;
detecting a behavior of said user from said first user image and generating first behavior information as a result of said operation to detect said behavior of said user as well as carrying out an operation to detect a behavior of said other user from said second user image and generating second behavior information of said other user as a result of said operation to detect said behavior of said other user;
generating a first command corresponding to said first behavior information of said user and a second command corresponding to said second behavior information of said other user;
determining a relation between said first and second commands;
informing said other information-processing apparatus of a result of said process carried out at said determination step through said network; and
controlling execution of processing corresponding to a result of said process carried out at said determination step.

11. An information-processing apparatus for communicating an image of a user to an other information-processing apparatus by way of a network, said information-processing apparatus comprising:
input means for carrying out an operation to take an image of a user and inputting a user image obtained as a result of said operation to take said image;
detection means for carrying out an operation to detect a behavior of said user from said user image and generating first behavior information as a result of said operation to detect said behavior;
notification means for notifying a predetermined server of said first behavior information through said network;
receiver means for receiving a determination result transmitted by said predetermined server in response to said first behavior information transmitted by said notification means to said predetermined server as a determination result on a state of a relation with second behavior information received by said predetermined server from said other information-processing apparatus; and
control means for controlling execution of processing corresponding to said determination result received by said receiver means.

12. The information-processing apparatus according to claim 11 wherein said predetermined server generates a first command corresponding to said first behavior information and a second command corresponding to said second behavior information received from said other information-processing apparatus as information on a behavior of a user operating said other information-processing apparatus, produces a determination result on a relation between said first and second commands and transmits said determination result to said information-processing apparatus.

13. The information-processing apparatus according to claim 11, said information-processing apparatus further having reproduction means for reproducing content data common to said information-processing apparatus and said other information-processing apparatus synchronously with said other information-processing apparatus.

14. An information-processing method for communicating an image of a user to an other information-processing apparatus by way of a network, said information-processing method comprising the steps of:
taking an image of a user and inputting a user image obtained as a result of said operation to take said image;
detecting a behavior of said user from said user image and generating first behavior information as a result of said operation to detect said behavior;
notifying a predetermined server of said first behavior information through said network;
receiving a determination result transmitted by said predetermined server in response to said first behavior information transmitted in a process carried out at said notification step to said predetermined server as a determination result on a state of a relation with second behavior information received by said predetermined server from said other information-processing apparatus; and
controlling execution of processing corresponding to said determination result received in a process carried out at said receiver step.

15. A recording medium for recording a program for communicating an image of a user to an other information-processing apparatus by way of a network wherein said program comprises the steps of:
taking an image of a user and inputting a user image obtained as a result of said operation to take said image;
detecting a behavior of said user from said user image and generating first behavior information as a result of said operation to detect said behavior;
notifying a predetermined server of said first behavior information through said network;
receiving a determination result transmitted by said predetermined server in response to said first behavior information transmitted in a process carried out at said notification step to said predetermined server as a determination result on a state of a relation with second behavior information received by said predetermined server from said other information-processing apparatus; and
controlling execution of processing corresponding to said determination result received in a process carried out at said receiver step.

16. A program for communicating an image of a user to an other information-processing apparatus by way of a network, said program comprising the steps of:
taking an image of a user and inputting a user image obtained as a result of said operation to take said image;
detecting a behavior of said user from said user image and generating first behavior information as a result of said operation to detect said behavior;
notifying a predetermined server of said first behavior information through said network;
receiving a determination result transmitted by said predetermined server in response to said first behavior information transmitted in a process carried out at said notification step to said predetermined server as a determination result on a state of a relation with second behavior information received by said predetermined server from said other information-processing apparatus; and
controlling execution of processing corresponding to said determination result received in a process carried out at said receiver step.

17. An information-processing apparatus for communicating an image of a user to an other information-processing apparatus by way of a network, said information-processing apparatus comprising:
an input section for carrying out an operation to take an image of a user and inputting a user image obtained as a result of said operation to take said image;
a detection section for carrying out an operation to detect a behavior of said user from said user image and generating behavior information as a result of said operation to detect said behavior;
a generation section for generating a first command corresponding to said behavior information;
a determination section for carrying out a process to determine a relation between said first command and a second command received from said other information-processing apparatus as a command corresponding to a behavior of an other user operating said other information-processing apparatus; and
a control section for controlling execution of processing corresponding to a result of said process carried out by said determination section.

18. An information-processing apparatus for communicating an image of a user to an other information-processing apparatus by way of a network, said information-processing apparatus comprising:
an input section for carrying out an operation to take an image of a user operating said information-processing apparatus and inputting a first user image obtained as a result of said operation to take said image;
a receiver section for receiving a second user image transmitted by said other information-processing apparatus by way of said network as an image of an other user operating said other information-processing apparatus;
a detection section for carrying out an operation to detect a behavior of said user from said first user image and generating first behavior information as a result of said operation to detect said behavior of said user as well as carrying out an operation to detect a behavior of said other user from said second user image and generating second behavior information of said other user as a result of said operation to detect said behavior of said other user;
a generation section for generating a first command corresponding to said first behavior information of said user and a second command corresponding to said second behavior information of said other user;
a determination section for carrying out a process to determine a relation between said first and second commands;
a communication section for informing said other information-processing apparatus of a result of said process carried out by said determination section through said network; and
a control section for controlling execution of processing corresponding to a result of said process carried out by said determination section.

19. An information-processing apparatus for communicating an image of a user to an other information-processing apparatus by way of a network, said information-processing apparatus comprising:
an input section for carrying out an operation to take an image of a user and inputting a user image obtained as a result of said operation to take said image;
a detection section for carrying out an operation to detect a behavior of said user from said user image and generating first behavior information as a result of said operation to detect said behavior;
a notification section for notifying a predetermined server of said first behavior information through said network;
a receiver section for receiving a determination result transmitted by said predetermined server in response to said first behavior information transmitted by said notification section to said predetermined server as a determination result on a state of a relation with second behavior information received by said predetermined server from said other information-processing apparatus; and
a control section for controlling execution of processing corresponding to said determination result received by said receiver section.
